(19) United States
(12) Patent Application Publication
(10) Pub. No.: US 2015/0150026 A1
(43) Pub. Date: May 28, 2015

(54) MESSAGING PROTOCOL

(71) Applicant: MIND CANDY LIMITED, London (GB)

(72) Inventor: Edwin LYONS, London (GB)

(21) Appl. No.: 14/553,561

(22) Filed: Nov. 25, 2014

(30) Foreign Application Priority Data
Nov. 25, 2013 (GB) 1320783.2
May 2, 2014 (GB) 1407858.8

(51) Int. Cl. G06F 9/54

(52) U.S. Cl. CPC G06F 9/546; G06F 9/542
USPC 719/313

(57) ABSTRACT

The present invention relates to a method of messaging between modules executing on one or more processors, including: a first module generating a plurality of events in response to an action; the first module storing two or more of the events into each frame of a plurality of frames; and transmitting the frames for receipt by a second module. A system implementing this method is also described.

### FIELD OF INVENTION

The present invention is in the field of messaging between modules. More particularly, but not exclusively, the present invention relates to messaging between modules that may be executing on separate threads.

### BACKGROUND

Traditionally systems which receive inputs, process the inputs to generate state changes within a model, and drive outputs from those state changes are constructed within a single module.

However, these traditional systems have many disadvantages, including the inability to compartmentalise the input system, processing system, and output system. Without compartmentalisation, each system is more difficult to independently develop, test, and deploy.

Accordingly, a best practice has developed in architecting such systems called Model-View-Controller (MVC). In this architecture, the input system (the Controller) mediates inputs (for example, from a user) and funnels the inputs to the processing system (the Model) which maintains a representation of information of the system (the state) and modifies said state in response to the inputs from the Controller. The changes to the state are, in turn, funnelled to the output system (the View) which controls output or display of the effect of the changed state, typically, to a user.

The MVC architecture also provides for easier execution of the Model, View and/or Controller on separate execution threads within hardware. This separation has various benefits, including limiting the impact of execution delays or failures within one thread on other threads, and providing for more efficient execution of systems by the operating system of the hardware, particularly, where the hardware includes multiple processors or multi-core processors.

To manage communication between the Model, View, and Controller threads first-in-first-out (FIFO) queues are used. That is, events are enqueued at one end of the queue by one system and dequeued from the other end by another system.

Unfortunately, some applications are ill-suited to development using an MVC architecture. For example, for interactive games the presentation logic (managed in the View) often needs to be closely coupled to the game logic (managed in the Model). This is because the user of the game expects responsive and consistent performance from the user interface which may require the game logic within the Model to manage synchronisation of the display of state changes by the presentation logic within the View. And effective synchronisation is not possible using a simple queue between the Model and the View as the messaging protocol.

It is an object of the present invention to provide an improved messaging protocol which overcomes the disadvantages of the prior art, or at least provides a useful alternative.

SUMMARY OF INVENTION

According to a first aspect of the invention there is provided a method of messaging between modules executing on one or more processors, including:

a) a first module generating a plurality of events in response to an action;

b) the first module allocating two or more of the events into each frame of a plurality of frames; and

c) transmitting the frames for receipt by a second module.

The second module may process all the events of a frame before processing the next frame.

The second module may process the events within a frame to generate effects. The second module may processes the event within the frame to generate synchronised effects. The effects may be output effects. The output effects may be object display, object animation, and/or sound generation.

The first module may be executing within a first thread and the second module may be executing within a second thread at the same device.

The first module may be executing logic managing a state. The logic may be game logic. Each changed state may be recorded.

In one embodiment, when the effect relates to a state change, the effect is concluded before processing of a subsequent frame.

The second module may be executing logic managing a view.

The frames may be transmitted to the second module via a queue.

One or more further modules may listen to one or more events within one or more frames transmitted to the second module.

The first module may receive the action from a third module. The third module may be a controller. The controller may receive input from a user.

Each frame may be recorded to a permanent storage.

In one embodiment, the first module may be executing at a first device and the second module may be executing at a second device. The devices may communicate via a networking communications protocol.

According to a further aspect of the invention there is provided a system, including:

one or more processors; and

a memory;

wherein the system is configured to execute a first module, said first module is configured, when executed, to generate a plurality of events in response to an action; to store two or more of the events into each frame of a plurality of frames; and to transmit the frames for receipt by a second module.

According to a first aspect of the invention there is provided a computer-implemented method for providing a game utilising a multi-threaded processing environment, including:

a) executing game logic within a first thread;

b) executing presentation logic within a second thread;

wherein the game logic transmits a plurality of synchronised events to the presentation logic.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention.

FIG. 2: shows a block diagram illustrating a system in accordance with another embodiment of the invention.

FIG. 3: shows a flow diagram illustrating a method in accordance with an embodiment of the invention.

FIG. 4: shows a diagram illustrating data flow between threads in accordance with an embodiment of the invention.

FIG. 5: shows a flow diagram illustrating the life-time of an event within an embodiment of the invention.

FIG. 6: shows a diagram illustrating an example of events within frames in accordance with an embodiment of the invention.

### DETAILED DESCRIPTION OF PREFERRED EMBODIMENTS

The present invention provides an improved messaging protocol to facilitate communication between modules executing on one or more processors, particularly, within separate threads and, particularly, to improve synchronisation.

The inventor has utilised the improved messaging protocol to devise a system for running the game logic for an animated puzzle or strategy game encapsulated and separated from the view logic on a separate thread using a combination of events and synchronisation points to keep the view in step. Other systems are able to interact with the events as they flow through the system and respond as they see fit.

The inventor observes that the standard way to write such a system would be to write both the game logic and view logic on a single thread. This is generally the most straightforward and predictable way to do so. In real-time games, the user experience of the game is closely tied to the user's perception of the performance—the smoothness of the game. Real-time games often run at between 30 and 60 frames per second. The perception of the smoothness of the game is a combination of the framerate of the game and how much variance there is in the framerate. For this reason (among others), it is generally considered to be good practice to separate the view logic from the application logic (as in the ‘Model View Controller’ programming pattern), but this is rarely done in games, as it adds complexity and often the presentational logic is very closely coupled to the game logic.

Puzzle and strategy games are often turn-based, and these games often have a number of actions that are performed by the user (who may be a real person, driven by an Al algorithm, or controlled by input that has been received via the internet) that trigger off a series of events in the game. A simple example would be a chess game—a player moving a piece might cause another player's piece to be removed from the board because they were taken by it, or may cause the player to win the game. Such a game could be presented in a wide variety of ways (artistically), but the core logic would remain the same.

An embodiment of the present invention provides a separation between game logic and view logic. This allows the game logic to be written as a pure simulation—modifying the data that makes up the state of the game and publishing events as that data is modified. This makes the game logic easier to write as it can be unit tested (as presentational logic isn't tied in) and functionally tested (as the inputs and outputs are clearly defined and can be easily analysed with tools). This, coupled with game logic that behaves in a deterministic way (as most puzzle and strategy games do), makes it easy to say that with a given state for the system, a certain set of input should always have a certain set of outputs (events). This is invaluable for a wide range of uses—replays, analytics, game recordings, testing (automatic and manual) and debugging.

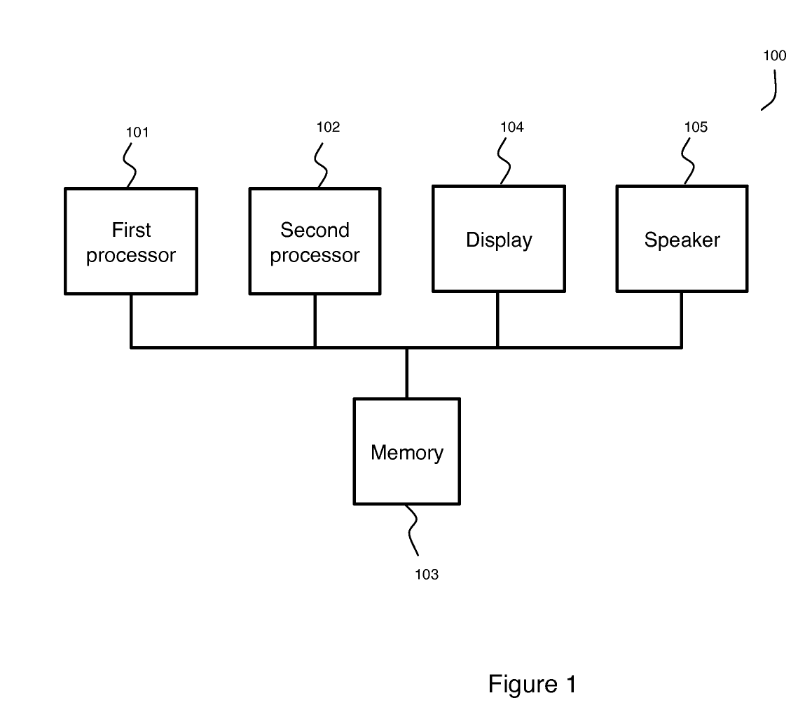

In FIG. 1, a system 100 in accordance with an embodiment of the invention is shown.

A first and second processor 101 and 102 are shown. It will be appreciated that these may be separate processors or they may represent multiple cores within a single processor.

In one embodiment, the system 100 comprises a single processor performing the function of both processors 101 and 102.

A memory 103 is shown. The memory 103 may be configured to store executable code for a first and second module.

The processors 101 and 102 may be configured to be connected to the memory 103.

The processors 101 and 102 may be configured for executing the first module.

The processors 101 and 102 may execute the first module within a first thread. The module, when executing, may generate a plurality of events in response to an action. The events may be allocated across a plurality of frames, such that a frame may comprise a plurality of events. The events may be allocated based upon which events should generate synchronous effects at the second module.

The first module, when executing, may transmit the plurality of frames for receipt by the second module. The first module may transmit the plurality of frames by enqueuing them to a FIFO queue stored within a memory.

The processors 101 and 102 may also be configured for executing a second module. The second module may execute within a second thread. The second module, when executing, may dequeue frames from the FIFO queue and process the events within the frames to generate effects. The effects may, for example, include the display of graphics or animations at a display 104, or the generation of sound at a speaker 105. The effects within a single frame may be generated to occur synchronously. All the events within a frame may be processed before events in a subsequent frame.

The display 104 and speaker 105 may be connected to the processors 101 and 102 by, for example, a bus.

It will be appreciated that although the first and second modules have been described as computer code, that the modules may be coded within firmware, or hard-wired within the processors.

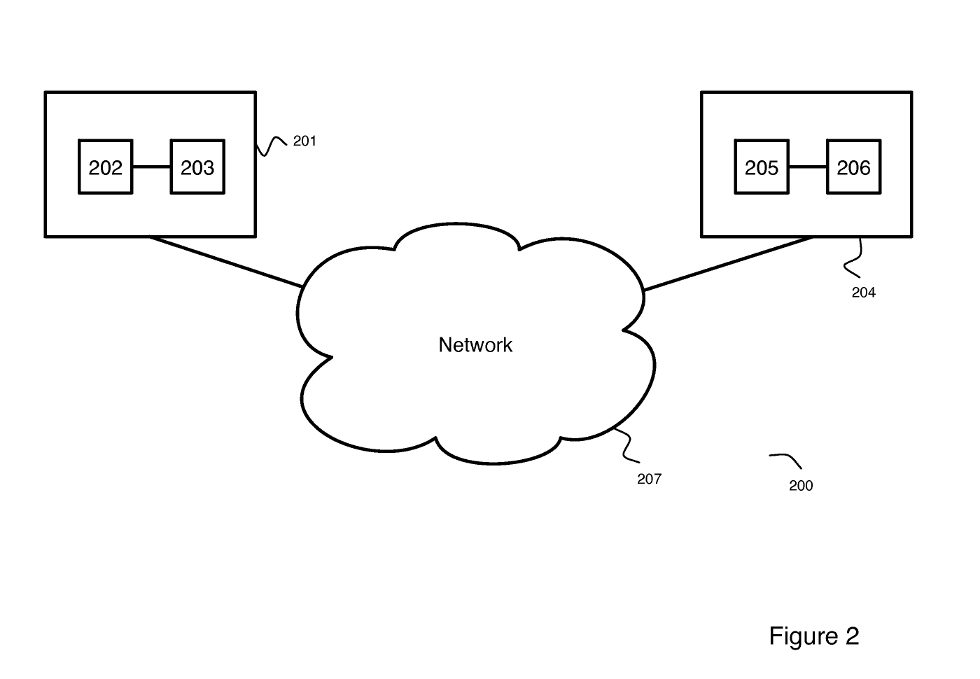

In FIG. 2, an alternative system 200 in accordance with an embodiment of the invention is shown.

A first device 201 is shown. The first device 201 includes a processor 202 and a memory 203 storing a first executable module. The first device 201 may be a server apparatus.

A second device 204 is shown. The second device 204 includes a processor 205 and a memory 206 storing a second executable module. The second device 204 may be user device such as a tablet, smartphone, desktop computer, or other personal computing device.

The first device 201 may be configured to execute a first module. The first module, when executing, may generate a plurality of events in response to an action.

The actions may be received from the second device 204 in response to user input.

The events may be allocated, by the first module, across a plurality of frames, such that a frame may comprise a plurality of events. The events may be allocated to the frames based upon which events should generate synchronous effects at the second device 204.

The first module, when executing, may transmit the plurality of frames for receipt by the second module at the second device 204. The frames may be transmitted to the second device 204 via a communications protocol and across, for example, a communications network 207 or combination of networks such as the Internet.

The second device 204 may be configured for executing a second module.

The second module, when executing, may receive the frames from the first device 201 and manage the frames in sequence to extract and process events within the frames to generate effects. The effects may include the display of graphics or animations at a display, or the generation of sound at a speaker. The effects within a single frame may be generated to occur synchronously at the second device 204. All the events within a frame may be processed before events in a subsequent frame.

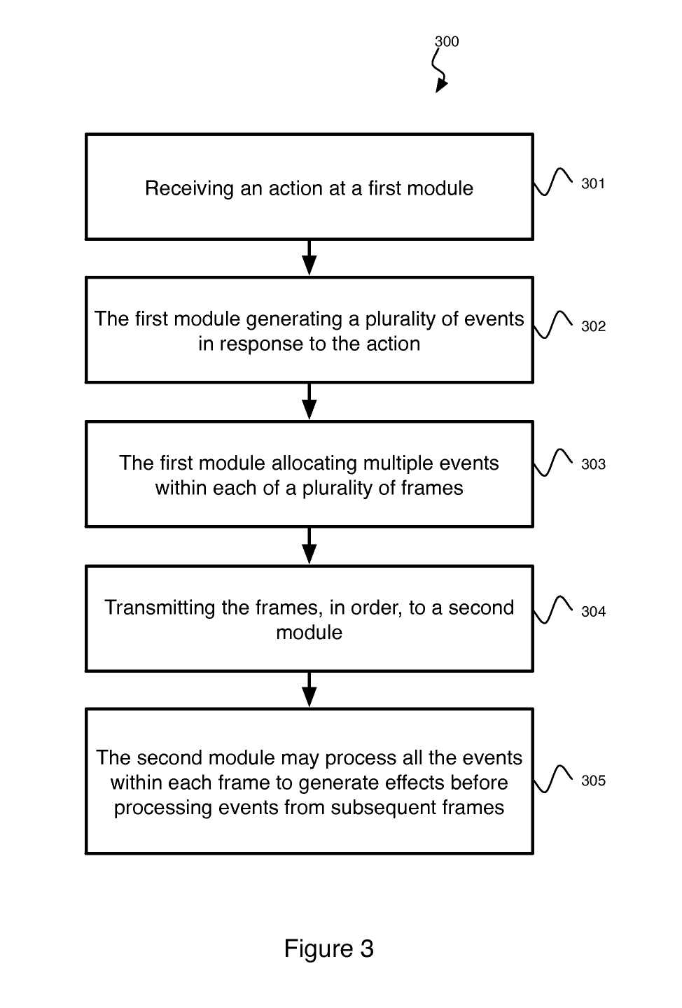

A method 300 in accordance with an embodiment of the invention will be described with reference to FIG. 3.

In step 301, an action may be received by first module. The action may be received from another module such as an input controller module. The action may result from a user action. The first module may be executing within a first thread on one or more processors. The first module may include state logic such as game logic.

In step 302, the first module may generate a plurality of events in response to the action.

In step 303, the first module may allocate multiple events to each of a plurality of frames based upon when the events should be processed. Steps 302 and 303 may overlap such that event generation proceeds in tandem with allocation of events to frames. Alternatively, the events could be buffered and/or ordered before allocation into frames.

In step 304, the first module may transmit the frames sequentially for receipt by the second module, for example, using a FIFO queue.

In step 305, the second module may retrieve the frames and process the events within each frame in sequence such that all the events within a frame are processed to generate effects before the events within the next frame are processed. The second module may be executing within a second thread on one or more processors. The second module may include presentation or view logic. The effects may include output effects such as the display of graphical objects or animations on a visual display or the generation of sound effects or music.

The second module may process all the events within the frame to ensure synchronised generation of the effects. For example, all the effects may be played back to the user at the same time.

Processing of all the effects within the frame may involve initiating effects which have a duration, for example, a sound effect or an animation. In one embodiment, all effects that relate to changes of state must be concluded before effects from the next frame are generated.

In one embodiment, the method includes the step of other modules listening to the events within the frames and/or recording the frames to permanent storage to facilitate replay of events or analysis, for example, for debugging. Recordal of frames may facilitate debugging by enabling monitoring of when or if events are displayed.

In one embodiment, the method includes the step of capturing state changes within the first module. These captured state changes may be used to facilitate independent module testing and to track bugs.

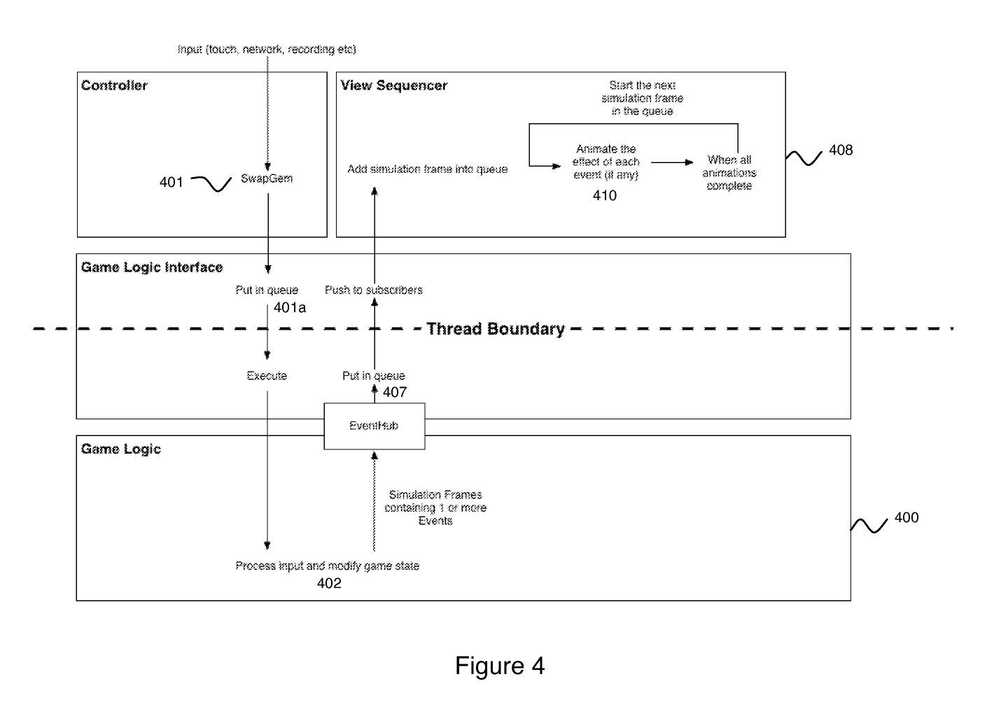

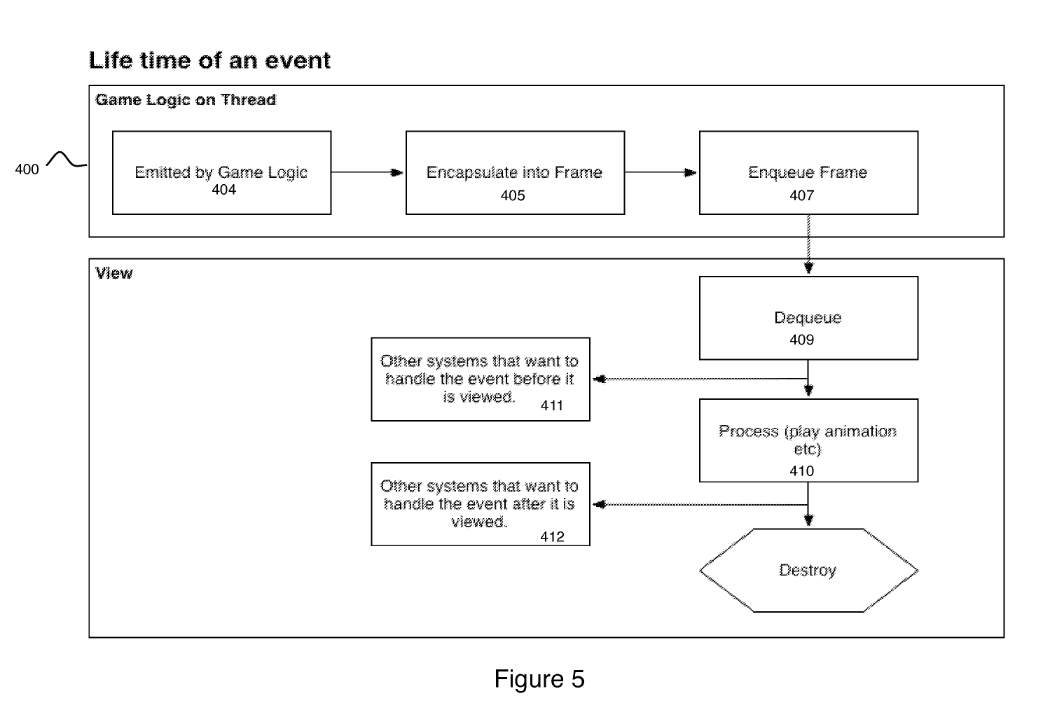

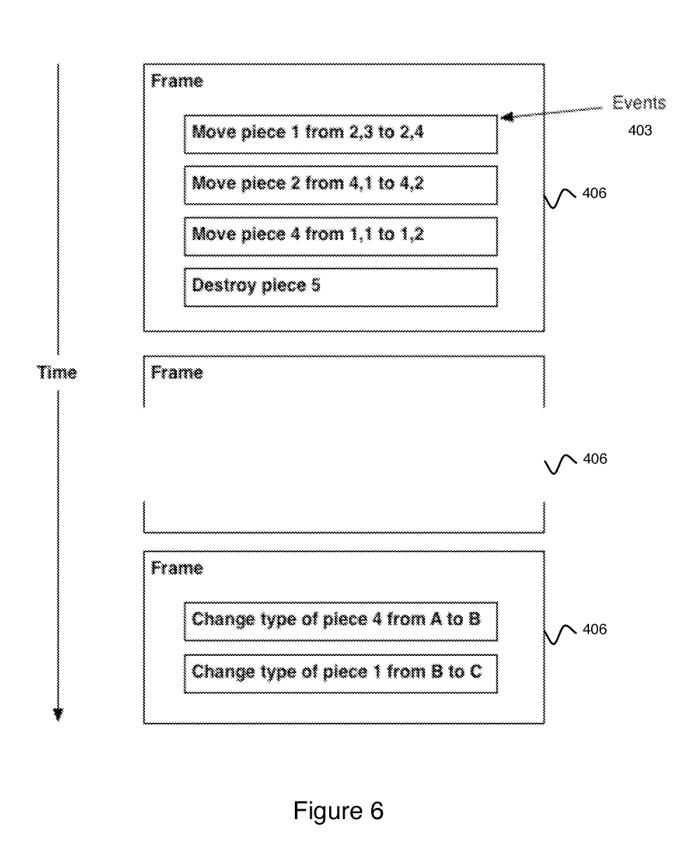

A method and system in accordance with an embodiment of the invention will be described with reference to FIGS. 4 to 6.

This embodiment will be described in relation to a game application.

a. A thread is started that runs all the game logic 400 for the game

b. To interact with the game logic 400, actions 401 are queued up 401a for the thread to process.

c. The thread runs in a loop, on each iteration it executes an action 401 from the queue.

d. The queue is protected by a mutex to prevent access from multiple threads.

e. The actions 401 trigger the execution of code that modifies the game state appropriately at 402. This can be complex and executed over many visual frames.

f. As the game state is modified, events 403 (packages of information about the changes) are emitted from the system at 404 and stored at 405 in frames 406.

g. Each frame 406 is a collection of events 403 that should be displayed to the user simultaneously.

h. The game logic 400 is responsible for deciding when a frame 406 is complete.

i. When a frame 406 is complete, it is added to a queue at 407.

j. This queue is also protected by a mutex.

k. Periodically, the view logic 408 can access the next frame 406 on the queue at 409.

l. Each time the view logic 408 gets a new frame 406 it makes a decision about what to do with each of the events 403 in the frame 406 at 410. In the normal case, this is to display it on the screen by creating objects to display on screen, or playing animations on existing on-screen objects.

m. Once all the events have been displayed, the next frame 406 (if any) is requested and the same process as in step (I) occurs.

n. The view logic 408 decides when an event 403 is considered to have been displayed. For example, it may play an animation and a sound for one particular event, but this does not mean that it needs to wait for the animation or sound to be complete before considering the event itself to have been viewed. This way, some events 403 across frames 406 can be shown in an overlapping manner, providing a fluid experience.

o. Any number of individual systems may listen to events 403 either before (at 411) or after (at 412) the view processes them (at 410), for example on-screen user interfaces may display scores, goals and animations in response to events.

p. Systems for tracking statistics may also use events 403 to gather data.

q. Systems may ignore events 403 that are not relevant to them.

In one embodiment of the invention, multiple different systems may control the flow of events through the view. The embodiment of the present invention described above expects a single view to be responsible for controlling the flow of events and deciding when an event is complete. However, there are situations when it would be beneficial to have multiple systems controlling event flow. This may allow for more modular code and division of responsibility.

In an alternative embodiment of the invention, the game logic could run on the same thread as the view logic, and only the event queuing and processing steps are used.

It will be appreciated that the view doesn't need to generate actual visual effects; the view output could be used for automated testing in which case nothing may be rendered to the screen.

In an alternative embodiment of the invention, instead of running the game logic on another thread, the game logic could run on a server and communicate with the client over a networking protocol. This could permit the game logic to be secure preventing, for example, cheating. In this case, the game logic could either be run on just the server, or both the server and the client, with the server being used to validate the moves the player makes. This could also be used to allow game logic to be updated without having to release new versions of the game.

In one embodiment, the inputs to the system (if the game logic is deterministic) or the events coming out of the system could be recorded to provide the user with replays that they can watch themselves or send to other users to watch.

Potential advantages of some embodiments of the present invention are that smoother performance is provided without having to carefully code game logic, a convenient system for sequencing visual and audio effects is provided, and the game logic may be cleanly encapsulated, allowing it to be used in different environments—separated from view logic—for automated testing, for example. Therefore, in some embodiments of the present invention, what has been provided is an improved method for providing communication between executing modules on devices(s) which causes device(s) to operate in a new and improved way and also provides an improved system to application software writers.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method of messaging between modules executing on one or more processors, including:
a) a first module generating a plurality of events in response to an action;
b) the first module allocating two or more of the events into each frame of a plurality of frames; and
c) transmitting the frames for receipt by a second module.

2. A method as claimed in claim 1, wherein the second module processes all the events of a frame before processing the next frame.

3. A method as claimed in claim 1, wherein the second module processes the events within a frame to generate effects.

4. A method as claimed in claim 3, wherein the second module processes the events within the frame to generate synchronised effects.

5. A method as claimed in claim 4, wherein the effects are output effects.

6. A method as claimed in claim 5, wherein the output effects include one or more from the set of object display, object animation, and sound generation.

7. A method as claimed in claim 1, wherein the first module is executing within a first thread and the second module is executing within a second thread at the same device.

8. A method as claimed in claim 1, wherein the first module executes logic managing a state.

9. A method as claimed in claim 8, wherein the logic is game logic.

10. A method as claimed in claim 8, wherein the second module processes the events within a frame to generate effects and wherein, when the effect relates to a state change, the effect is concluded before processing of a subsequent frame.

11. A method as claimed in claim 8, wherein each changed state is recorded.

12. A method as claimed in claim 1, wherein the second module executes logic managing a view.

13. A method as claimed in claim 1, wherein the frames are transmitted to the second module via a queue.

14. A method as claimed in claim 1, wherein one or more further modules listen to one or more events within one or more frames transmitted to the second module.

15. A method as claimed in claim 1, wherein the first module receives the action from a third module.

16. A method as claimed in claim 15, wherein the third module is a controller.

17. A method as claimed in claim 16, wherein the controller receives input from a user.

18. A method as claimed in claim 1, wherein each frame is recorded to a permanent storage.

19. A method as claimed in claim 1, wherein the first module is executing at a first device and the second module is executing at a second device.

20. A method as claimed in claim 19, wherein the devices communicate via a networking communications protocol.

21. A system, including:
one or more processors; and
a memory;
wherein the system is configured to execute a first module, said first module is configured, when executed, to generate a plurality of events in response to an action; to store two or more of the events into each frame of a plurality of frames; and to transmit the frames for receipt by a second module.

22. A system as claimed in claim 21, wherein the system is further configured to execute the second module.

23. A system as claimed in claim 22, wherein the second module is configured, when executed, to process all the events of a frame before processing the next frame.

24. A computer readable storage medium having stored therein instructions, which when executed by a processor of a device cause the device to perform the method of claim 1.

25. A computer-implemented method for providing a game utilising a multi-threaded processing environment, including:
a) executing game logic within a first thread;
b) executing presentation logic within a second thread;
wherein the game logic transmits a plurality of synchronised events to the presentation logic.
